(19) United States
(12) Patent Application Publication
(10) Pub. No.: US 2026/0063519 A1
(43) Pub. Date: Mar. 5, 2026

(54) PARTICLE DETECTION METHODS AND SYSTEMS

(71) Applicant: Samsung Electronics Co., Ltd., Suwon-si (KR)

(72) Inventors: Hyori LEE, Suwon-si (KR); Yunho KIM, Suwon-si (KR); Sung Bae KIM, Suwon-si (KR); Younghun KIM, Suwon-si (KR); Pil-Mo KWAK, Suwon-si (KR); Jun Young OH, Suwon-si (KR); Seok Hwan LEE, Suwon-si (KR); Jinhyeok JANG, Suwon-si (KR)

(21) Appl. No.: 19/066,272

(22) Filed: Feb. 28, 2025

(30) Foreign Application Priority Data
Aug. 28, 2024 (KR) 10-2024-0116284

(51) Int. Cl. G01N 1/40; G01N 1/38; G01N 15/075

(52) U.S. Cl. CPC G01N 1/4055; G01N 1/38; G01N 1/4077; G01N 2001/4088; G01N 15/075

(57) ABSTRACT

In accordance with the present disclosure, there may be provided a particle detection method and system with the improved detection ability for fine particles, such as metals, metalloids, and/or compounds thereof, dissolved in a polar solvent. Particle detection methods include performing preprocessing of an analysis sample in which fine particles are dissolved in a polar solvent, and introducing the precipitated fine particles to an analyzer configured to detect particles. Preprocessing may include mixing the analysis sample in which fine particles are dissolved in a polar solvent, with a supercritical fluid; precipitating the fine particles to form a mixture of polar solvent with precipitated fine particles, and supercritical fluid; and separating the polar solvent from the precipitated fine particles.

### CROSS-REFERENCE TO RELATED APPLICATION

This U.S. nonprovisional application claims priority to Korean Patent Application No. 10-2024-0116284 filed on Aug. 28, 2024, and all the benefits accruing therefrom under 35 U.S.C. § 119, the contents of which are hereby incorporated by reference in their entirety.

### BACKGROUND

The present disclosure relates to a particle detection method and system.

As semiconductor devices become more advanced, the impact of defects caused by fine particles is increasing. In particular, fine particle impurities in semiconductor cleaning liquids may become residues on semiconductor wafers, resulting in significant yield losses, and thus the importance of impurity control in semiconductor chemical materials is being emphasized. However, currently used ion and particle detectors for chemical-materials, such as an inductively coupled plasma mass spectrometer (ICP-MS) or a laser particle counter (LPC), have technical limitations in distinguishing between impurities and noise, and in particular, have significantly poor detection capabilities for dissolved silicon impurities with a particle diameter size of less than 20 nm. In order to effectively analyze, monitor, and control chemical materials within a process, a detector with high analytical sensitivity is required, but the current situation is that there is no particle detector capable of replacing the current particle detector.

### SUMMARY

The present disclosure provides a particle detection method and system with the improved detection ability for fine particles, such as metals, metalloids, and/or compounds thereof, dissolved in a polar solvent.

The effects of present disclosure are not limited to those mentioned above, and other effects not mentioned will be clearly understood by those skilled in the art from the following description.

In accordance with an exemplary embodiment of the present disclosure, a particle detection method includes performing preprocessing of an analysis sample in which fine particles are dissolved in a polar solvent. The performing of the preprocessing includes mixing the analysis sample in which fine particles are dissolved in a polar solvent, with a supercritical fluid and precipitating the fine particles to form a mixture of polar solvent with precipitated fine particles, and supercritical fluid; and separating the polar solvent from the precipitated fine particles. Example methods may include introducing the precipitated fine particles to an analyzer configured to detect particles.

In accordance with other exemplary embodiments of the present disclosure, a particle detection system includes a preprocessor and an analyzer, in which the preprocessor includes a supercritical fluid storage container configured to contain supercritical fluid, an extractor configured to precipitate fine particles from an analysis sample by mixing the analysis sample with the supercritical fluid, and a separator configured to separate precipitated fine particles and a solvent discharged from the extractor from the supercritical fluid.

In accordance with still other exemplary embodiments of the present disclosure, a particle detection method includes performing preprocessing of an analysis sample. Performing of the preprocessing includes introducing the analysis sample in which a silicon precursor is dissolved in high-concentration sulfuric acid into an extractor, mixing supercritical carbon dioxide from a supercritical carbon dioxide storage container into the extractor, precipitating the silicon precursor from the analysis sample by adjusting a temperature or a pressure of the extractor to produce precipitated silicon precursor, and separating a solvent mixed with the precipitated silicon precursor in a separator. In an exemplary embodiment, the temperature of the extractor in the mixing of the supercritical carbon dioxide from the supercritical carbon dioxide storage container into the extractor is 32° C. to 200° C. and the pressure of the extractor in the mixing of the supercritical carbon dioxide from the supercritical carbon dioxide storage container into the extractor is 74 bar to 300 bar, and the temperature and pressure in the precipitating of the silicon precursor from the analysis sample are adjusted to 32° C. to 85° C. and 130 bar to 250 bar, respectively.

Details of other exemplary embodiments are included in the Detailed Description and drawings.

### BRIEF DESCRIPTION OF THE DRAWINGS

Exemplary embodiments can be understood in more detail from the following description taken in conjunction with the accompanying drawings, in which:

FIG. 1 is a schematic view of a particle detection system in accordance with some exemplary embodiments of the present disclosure;

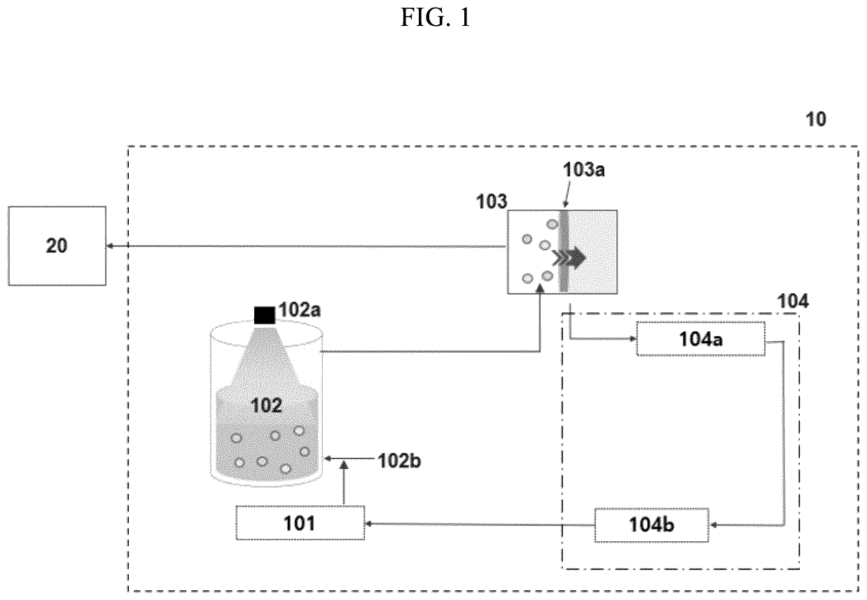

FIG. 2 is a flowchart of a particle detection method in accordance with some exemplary embodiments of the present disclosure; and

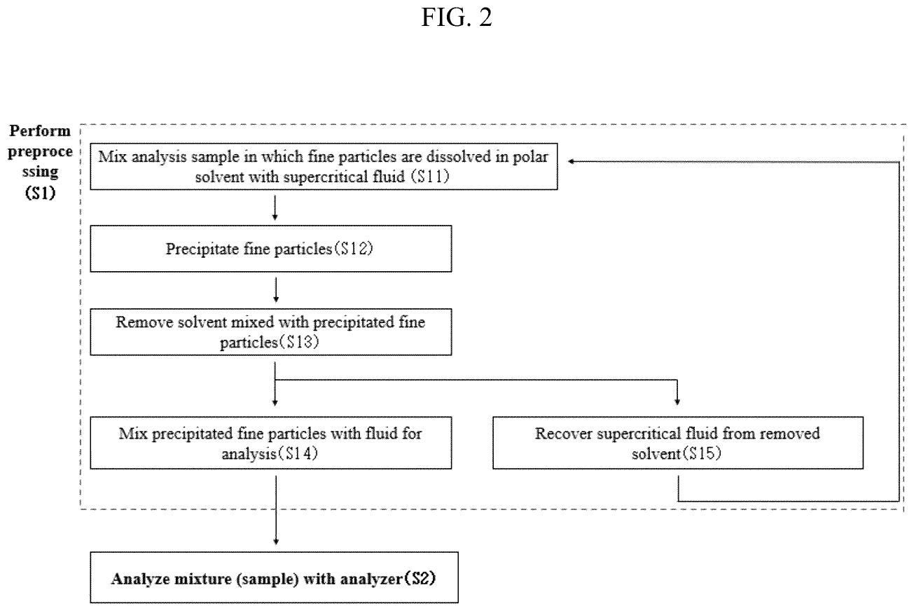

FIG. 3 is another flowchart of a particle detection method in accordance with some exemplary embodiments of the present disclosure.

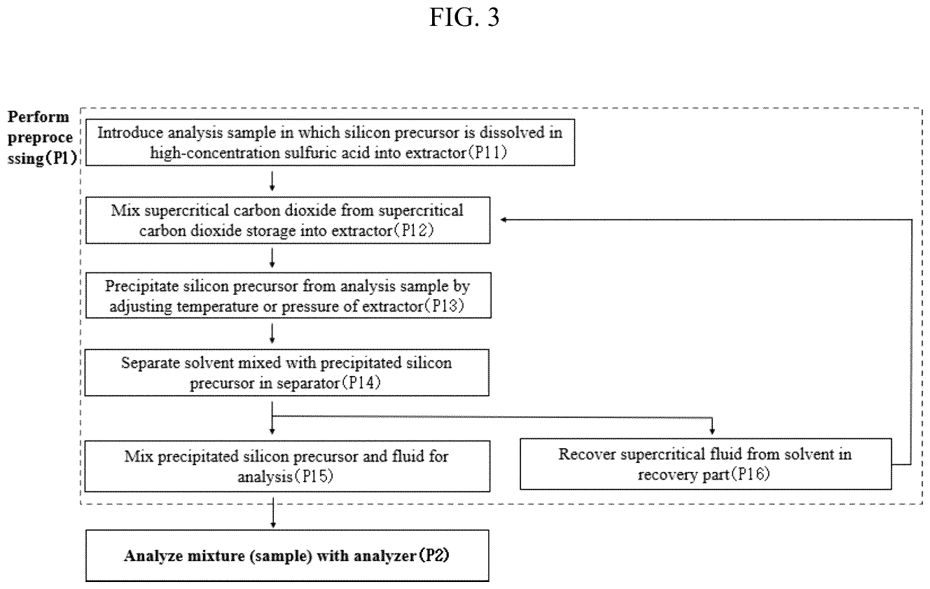

### DETAILED DESCRIPTION OF EMBODIMENTS

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

Therefore, configurations of exemplary embodiments described in the present specification are merely exemplary embodiments of the present disclosure, and are not intended to fully describe the technical aspects of the present disclosure, so it should be understood that a variety of other equivalents and modifications could be made thereto at the time of filing the application.

Items described in the singular herein may be provided in plural, as can be seen, for example, in the drawings. Thus, the description of a single item that is provided in plural should be understood to be applicable to the remaining plurality of items unless context indicates otherwise. In the present specification, when a part “comprises” an element, unless described to the contrary, the term “comprises” does not indicate that the part excludes another element but instead indicates that the part may further include the other element.

Throughout the specification, when a component is described as “including” or “having” or “comprising” a particular element or group of elements, it is to be understood that the component is formed of only the element or the group of elements, or the element or group of elements may be combined with additional elements to form the component, unless the context indicates otherwise. The term “consisting of,” on the other hand, indicates that a component is formed only of the element(s) listed.

Whenever in the present specification, an amount, concentration, or other value or parameter is given as either a range, a range, or a list of upper values and lower values, it should be understood as specifically disclosing all ranges that may be formed from any pair of any upper range limit or value and any lower range limit or value, regardless of ranges are separately disclosed. When a range of numerical values is recited in the present disclosure, unless otherwise stated, for example, if there are no qualifying terms such as greater than, less than, etc., the range is intended to include the endpoints thereof, and all integers and fractions within the range. It is not intended that the scope of the present disclosure is limited to the specific values recited when defining a range.

Among physical properties mentioned in the present specification, when the measured temperature affects relevant physical properties, the physical properties are assumed to be measured at room temperature, unless otherwise specified. The term room temperature is the natural temperature that is not heated or cooled, and may mean, for example, any temperature within the range of 10° C. to 30° C., 22° C. to 26° C., or 23° C. or 25° C. In addition, unless otherwise specified, the unit of temperature in the present specification is ° C.

In addition, among physical properties mentioned in the present specification, when the measured pressure affects relevant physical properties, the physical properties are measured at normal pressure, for example, atmospheric pressure (approximately 1 atm), unless otherwise specified.

An aspect of the present disclosure relates to a particle detection method.

A particle detection method in accordance with an exemplary embodiment is a particle detection method including operation S1 of performing preprocessing prior to introduction of an analyzer, and operation S1 of performing preprocessing may include operation S11 of mixing an analysis sample in which fine particles are dissolved in a polar solvent with a supercritical fluid and operation S12 of precipitating the fine particles.

In the present specification, fine particles may mean, for example, impurities that may adversely affect the performance or manufacturing process of semiconductor devices. In the present specification, fine particles may mean, for example, particles having a particle diameter size of less than 20 nm, and in other examples, particles having a particle diameter size of less than 15 nm, less than 10 nm, or less than 5 nm. The “particle diameter size” refers to the diameter size of individual particles. It should be understood that within a group or set of particles, some particles may fall outside the indicated “particle diameter size” indicated herein. For example, the mean or median particle diameter size may be within the indicated range, such as less than 20 nm, and fall within the scope of embodiments of the present application, even if there are some outlying particles that have a particle diameter size larger than the indicated size.

The present disclosure may perform the operation of performing preprocessing on the analysis sample before introduction of a sample having precipitated fine particles to the analyzer as described herein, thereby making it possible to increase the detection capability of fine particles that are difficult to detect, and as a result, taking preemptive measures to prevent fine particles that are difficult to detect due to their small size or low concentration but may have a fatal effect on semiconductor devices from being introduced into the semiconductor process, or even when the fine particles are introduced, to be introduced only at a concentration below a certain level. As a result, it is possible to reduce the occurrence of semiconductor quality problems caused by fine particles, and also to promote productivity improvement.

The fine particles and precipitated fine particles in accordance with an exemplary embodiment may be at least one material selected from the group consisting of metals, metalloids, and/or compounds thereof. The metals and/or compounds thereof may be, for example, iron (Fe), copper (Cu), nickel (Ni), aluminum (Al), lead (Pb), silver (Ag), thallium (Tl), cadmium (Cd), and/or compounds thereof, but are not limited thereto. The metalloids and/or compounds thereof may be silicon (Si), antimony (Sb), arsenic (As), tellurium (Te), selenium (Se) and/or compounds thereof, but are not limited thereto. In the present specification, the metal compound or metalloid compound may include a precursor thereof. The metalloid compounds may include, for example, a silicon precursor, and the silicon precursor may be, for example, silanes, chlorosilanes, alkoxysilanes, organosilanes, or the like. However, the metals, metalloids, and/or compounds thereof are not limited to those exemplified above, and may include all metals that may be generated, particularly in processes for manufacturing semiconductor devices.

In the present specification, the polar solvent may mean, for example, a solvent used in the processes for manufacturing semiconductor devices. More specifically, for example, the polar solvent may refer to a polar solvent used in the processes for manufacturing semiconductor devices, such as a wafer surface cleaning process, an oxide removal process, an oxidation process, a chemical mechanical polishing, or the like.

The polar solvent in accordance with an exemplary embodiment may be at least one polar solvent selected from the group consisting of water; an inorganic solvent containing sulfuric acid, phosphoric acid, hydrochloric acid, nitric acid, hydrofluoric acid, ammonium hydroxide, hydrogen peroxide, or the like; and an organic solvent containing acetic acid, dimethyl sulfoxide, methyl alcohol, ethyl alcohol, isopropyl alcohol, ethanol amine, tetramethylammonium hydroxide, or the like.

The polar solvent in accordance with an exemplary embodiment may be at a high concentration. In the present specification, high concentration may refer to a concentration greater than or equal to about 16 M, greater than or equal to about 16.9 M, or greater than or equal to about 18 M. Therefore, when conducting an impurity test before introducing the polar solvent into the semiconductor process, the polar solvent is needed to be diluted to perform the analysis. However, because the fine particles such as metals, metalloids, and/or compounds thereof, dissolved in the polar solvent, have small particle diameter sizes and are contained at low concentrations, when the polar solvent is diluted, the concentration of the fine particles becomes even lower, and thus detection through the analyzer may become even more difficult.

To overcome the limitations of the detection capability of fine particles dissolved in such a polar solvent, the present disclosure introduces a preprocessing operation prior to introduction of the analyzer, and incorporates supercritical fluid extraction (SFE) into the preprocessing operation. In the present specification, the supercritical fluid extraction (SFE) may refer to a method of extracting a substance using a supercritical fluid, and the supercritical fluid may refer to a substance in a state in which, when a substance is heated above its critical point and pressure is applied to the substance, a boundary between liquid and gas disappears and the substance has unique physical properties.

In accordance with an exemplary embodiment, the supercritical fluid may be at least one fluid selected from the group consisting of carbon dioxide, ethane, ethylene, propane, propylene, and chlorotrifluoromethane. Although there are no specific restrictions on the substance as long as the substance is non-reactive with the polar solvent contained in the analysis sample and has a critical point below a range that may cause their decomposition, it may be desirable to use, as the supercritical fluid, carbon dioxide, which is an environmentally friendly material that is inert and harmless to the human body, and economical in terms of manufacturing.

The particle detection method in accordance with an exemplary embodiment may be characterized in that an operation of mixing the analysis sample and the supercritical fluid is performed at a temperature of 32° C. to 200° C., or under a pressure of 74 bar to 300 bar. The temperature and/or pressure of an operation of introducing the supercritical fluid into the analysis sample may refer to a temperature and/or a pressure of an extraction tank described below. By mixing the analysis sample and the supercritical fluid at the temperature and/or under the pressure, the fine particles may be effectively precipitated or extracted without being dissolved.

Operation S11 of mixing the analysis sample and the supercritical fluid in accordance with an exemplary embodiment may be characterized by mixing the analysis sample with the supercritical fluid at 1 to 10% (volume ratio).

The particle detection method in accordance with an exemplary embodiment may be characterized in that operation S12 of precipitating the fine particles includes an operation of adjusting the pressure to a range of 130 bar to 250 bar. Operation S12 of precipitating the fine particles may be characterized by including, in other examples, an operation of adjusting the pressure to 140 bar or more, 150 bar or more, 160 bar or more, 170 bar or more, 180 bar or more, 190 bar or more, or 200 bar or more, or adjusting the pressure to 240 bar or less, 230 bar or less, 220 bar or less, 210 bar or less, 200 bar or less, 190 bar or less, 180 bar or less, 170 bar or less, 160 bar or less, or 150 bar or less. The pressure of the operation of precipitating the fine particles may refer to the pressure of the extraction tank described below.

Operation S12 of precipitating fine particles in accordance with an exemplary embodiment may be characterized by including an operation of adjusting the temperature to a range of 32° C. to 85° C. The operation of precipitating the fine particles may be characterized by including, in other examples, an operation of adjusting the temperature to 35° C. or higher, 40° C. or higher, 45° C. or higher, 50° C. or higher, 55° C. or higher, 60° C. or higher, or 65° C. or higher, or adjusting the temperature to 80° C. or lower, 75° C. or lower, 70° C. or lower, 65° C. or lower, 60° C. or lower, 55° C. or lower, or 50° C. or lower. The temperature of the operation of precipitating the fine particles may refer to the temperature of the extraction tank described below.

In the present disclosure, in operation S11 of mixing the analysis sample and the supercritical fluid and/or operation S12 of precipitating the fine particles, by adjusting the pressure and/or temperature of the extraction tank within a predetermined range and at a predetermined speed, the fine particles included in the analysis sample may be precipitated to a level that may be analyzed by the analyzer. In addition, in the present disclosure, operation S11 of mixing the analysis sample and the supercritical fluid and operation S12 of precipitating fine particles may be simultaneously performed, or may be performed at different times. When performed at different times, operation S12 of precipitating the fine particles may be performed after operation S11 of mixing the analysis sample and the supercritical fluid.

The particle diameter size of the precipitated fine particles in accordance with an exemplary embodiment may be 20 nm to 5 μm. The particle size of the precipitated fine particles may be, in other examples, 30 nm to 5 μm, 40 nm to 5 μm, or 50 nm to 5 μm, or 20 nm to 4 μm, 20 nm to 3 μm, 20 nm to 2 μm, or 20 nm to 1 μm. As indicated herein, the “particle diameter size” refers to the diameter size of individual particles. Within a group or set of particles, some individual particles may fall outside the indicated “particle diameter size” and still meet the scope herein. For example, the mean or median particle diameter size may be smaller than or greater than an indicated size range, and fall within the scope of embodiments of the present application, even if there are some outlying individual particles that have a particle diameter size outside the indicated size. Because the particle size of the fine particle precipitate is within the aforementioned range, analysis of the concentration of the fine particles included in the analysis sample is possible, which may ultimately contribute to improving the quality of semiconductor devices.

The operation of performing preprocessing in accordance with an exemplary embodiment may further include operation S13 of separating the polar solvent mixed with the precipitated fine particles. The polar solvent may be, for example, a polar solvent in which at least some or all of the fine particles are excluded by precipitation in the aforementioned polar solvent and in which the supercritical fluid is additionally dissolved.

Operation S1 of performing preprocessing in accordance with an exemplary embodiment may further include operation S15 of recovering the supercritical fluid from the separated polar solvent. Operation S15 of recovering the supercritical fluid from the separated polar solvent may include, for example, an operation of depressurizing the separated solvent, an operation of cooling, an operation of heating, and/or an operation of pressurizing. The operation of depressurizing the separated polar solvent may be characterized by depressurizing the separated solvent to, for example, a pressure of 5 bar or more and less than 74 bar. The operation of depressurizing the separated solvent may be characterized by, in other examples, depressurizing the separated solvent to a pressure of 10 bar or more, 15 bar or more, 20 bar or more, 25 bar or more, 30 bar or more, 35 bar or more, 40 bar or more, 45 bar or more, 50 bar or more, 55 bar or more, or 60 bar or more, or depressurizing the separated solvent to a pressure of less than 70 bar, less than 65 bar, less than 60 bar, less than 55 bar, less than 50 bar, less than 45 bar, less than 40 bar, less than 35 bar, or less than 30 bar. The gas form of the supercritical fluid may be recovered through the operation of depressurizing the separated polar solvent. Then, the operation of cooling the recovered gas may be characterized by reducing the temperature to, for example, −56° C. or higher and less than 32° C. The operation of cooling the recovered gas may be characterized by, in other examples, reducing the temperature to a temperature of −50° C. or higher, −45° C. or higher, −40° C. or higher, −35° C. or higher, −30° C. or higher, −25° C. or higher, −20° C. or higher, −15° C. or higher, −10° C. or higher, −5° C. or higher, or −0° C. or higher, or reducing the temperature to a temperature of less than 30° C., less than 25° C., less than 20° C., less than 15° C., less than 10° C., less than 5° C., or less than 0° C. In this way, the gas may be liquefied. Next, the operation of heating the liquefied gas and/or the operation of pressurizing the liquefied gas may be performed. The operation of heating the liquefied gas may be characterized by heating the liquefied gas to a temperature of, for example, 32° C. or higher. The operation of heating the liquefied gas may be characterized by, in other examples, heating the liquefied gas to a temperature of 35° C. or higher, 40° C. or higher, 45° C. or higher, 50° C. or higher, 55° C. or higher, 60° C. or higher, 65° C. or higher, or 70° C. or higher, or heating the liquefied gas to a temperature of 100° C. or lower, 90° C. or lower, 80° C. or lower, 70° C. or lower, 60° C. or lower, 50° C. or lower, or 40° C. or lower. The operation of pressurizing the liquefied gas may be characterized by pressurizing the liquefied gas to a pressure of, for example, 74 bar or more. The operation of pressurizing the liquefied gas may be characterized by, in other examples, pressurizing the liquefied gas to a pressure of 80 bar or more, 85 bar or more, 90 bar or more, 95 bar or more, 100 bar or more, 110 bar or more, 120 bar or more, 130 bar or more, 140 bar or more, or 150 bar or more, or pressurizing the liquefied gas to a pressure of 200 bar or less, 180 bar or less, 160 bar or less, 150 bar or less, 140 bar or less, 130 bar or less, 120 bar or less, 110 bar or less, or 100 bar or less. The operation of heating the liquefied gas and the operation of pressurizing the liquefied gas may be performed simultaneously or at different times, and the order may not be limited. By going through the operation of recovering the supercritical fluid, the supercritical fluid may be reused multiple times for the process of precipitating fine particles from the analysis sample, thereby further increasing economic efficiency.

Operation S1 of performing preprocessing in accordance with an exemplary embodiment may further include operation S14 of mixing the precipitated fine particles with an analysis fluid for analysis, e.g. in an analyzer. The mixture of the precipitated fine particles and the fluid for analysis may be referred to as a sample. The fluid for analysis may be ultrapure water, but is not limited thereto.

The particle detection method in accordance with an exemplary embodiment may further include operation S2 of analyzing the mixture (sample) with the analyzer. The analyzer may be an inductively coupled plasma mass spectrometer (ICP-MS) or a laser particle counter (LPC). The inductively coupled plasma mass Spectrometer (ICP-MS) is a type of analyzer that enables accurate analysis of trace elements in a sample, and any known ICP-MS may be used without limitation. The ICP-MS may include, for example, a sample introduction system, an inductively coupled plasma torch (ICP torch), an ion optics system, a mass analyzer, and/or a detector. The sample introduction system may include, for example, a nebulizer that serves to convert a liquid sample into a fine aerosol form, and/or a spray chamber that stabilizes the aerosol and removes large droplets. The inductively coupled plasma torch may include a plasma generator that generates a plasma of, for example, 6000 to 10000 K to atomize and/or ionize the sample. The ion optical system may focus and transport generated ions, for example, using an ion lens, and deliver the ions to the mass analyzer. The mass analyzer may be a quadrupole mass analyzer, a time-of-flight mass analyzer, and/or a dual-focus mass analyzer, but is not limited thereto. The detector may, for example, serve to amplify a detected ion signal and convert the amplified signal into an electrical signal. The ICP-MS may, for example, introduce the sample so that the sample is converted into a fine aerosol through a nebulizer and then the aerosol moves to a plasma torch through a spray chamber. Subsequently, a high-temperature plasma is generated in the plasma torch, and the sample converted into the aerosol may be exposed to the plasma to be atomized and/or ionized. Then, the generated ions are focused through the ion optical system and transported to the mass analyzer, and the ions may be separated through the mass analyzer according to, for example, a mass-to-charge ratio, and the separated ions may reach the detector to be converted into an electrical signal, so that the components and/or concentrations of the sample may be analyzed through the signal. The laser particle counter (LPC) is a type of analyzer that measures the particle diameter size and number of particles existing in the air or liquid, and may be used to monitor particle contamination levels in the air or liquid. As the LPC, anything known may be used without restriction. The LPC may include, for example, a laser light source, a sampling system, an optical system, a data processing system, and/or a liquid flow cell. The sample may be introduced into the flow cell, for example, through the sampling system. In this case, a pump, a syringe, or the like, may be used to introduce the sample. As the sample passes through the flow cell, the laser light source shines light on particles within the sample, and the particles may scatter light as the particles pass through a laser beam. In this case, the scattered light may be detected by the detector, and the detected signal may be converted into an electrical signal through the data processing system, so that the components and/or concentration of the sample may be analyzed.

A second aspect of the present disclosure relates to a particle detection system.

Unless specifically stated otherwise, matters relating to the first aspect of the present disclosure may be equally applied to matters relating to the second aspect.

The particle detection system in accordance with an exemplary embodiment may include a preprocessor 10 and an analyzer 20, in which the preprocessor 10 may include a supercritical fluid storage container 101, an extractor 102 configured to precipitate fine particles from an analysis sample by mixing the supercritical fluid, and a separator 103 configured to separate precipitated fine particles and a solvent discharged from the extractor 102.

The supercritical fluid storage container 101 in accordance with an exemplary embodiment may be a space for storing the supercritical fluid before introduction of the extractor 102, and may be used without any special restrictions as long as the storage container is designed to stably operate at a temperature and pressure higher than a critical temperature and pressure of the supercritical fluid. The supercritical fluid storage container 101 may be designed as a spherical or cylindrical structure, for example, to evenly distribute pressure, but is not limited thereto. A wall thickness of the supercritical fluid storage container 101 may be appropriately designed by considering an operating pressure, a diameter of the supercritical storage container 101, an allowable stress of the material, and the like. The material of the supercritical fluid storage container 101 is not limited as long as the material is a material that is not reactive with the supercritical fluid and is capable of withstanding high temperature and/or high pressure conditions, and as an example, high-strength stainless steel or alloy steel may be used.

The supercritical fluid storage container 101 in accordance with an exemplary embodiment may include a temperature sensor and/or a pressure sensor capable of monitoring a state within the supercritical fluid storage container 101 in real time, because the temperature and/or pressure is needed to be adjusted depending on the type of supercritical fluid.

The supercritical fluid storage container 101 in accordance with an exemplary embodiment may include a pressure relief valve to safely release pressure in an overpressure situation. The pressure relief valve may be designed to automatically open and close when the pressure exceeds a predetermined range, or may manually open and close by an operator.

The extractor 102 in accordance with an exemplary embodiment may be a space for precipitating the fine particles from the analysis sample, and may include an analysis sample input part 102a containing fine particles and a supercritical fluid injection part 102b. Through the analysis sample input part 102a, the analysis sample containing the fine particles is input into the extractor 102, and the opening and closing of the analysis sample input part 102a may be automatically or manually controlled through a valve or the like. The supercritical fluid injection part 102b may perform a role of injecting the supercritical fluid supplied from the supercritical fluid storage container 101 into the extractor. In example embodiments, the supercritical fluid injection part 102b may include a high-pressure nozzle and/or a pressure control sensor that may inject the supercritical fluid into the extractor at a constant speed or at a speed that varies in multiple stages. The analysis sample may be added to the extractor 102 before, after or concurrently with the addition of the supercritical fluid to the extractor.

The extractor 102 in accordance with an exemplary embodiment may include a temperature sensor and/or a pressure sensor capable of monitoring a state within the extractor in real time, and may further include a system capable of controlling a temperature reduction or heating speed and/or a depressurization or pressurization speed.

In accordance with an exemplary embodiment, the extractor 102 may maintain a temperature of 32° C. to 200° C., or 40° C. to 180° C. and/or a pressure of 74 bar to 300 bar, or 80 bar to 250 bar when the analysis sample is mixed with the supercritical fluid.

In accordance with an exemplary embodiment, the extractor 102 may be controlled to reach a temperature of 32° C. to 85° C. or 35° C. to 80° C. when precipitating the fine particles from the analysis sample.

In accordance with an exemplary embodiment, the extractor 102 may be controlled to reach a pressure of 130 bar to 250 bar or 150 bar to 230 bar when precipitating the fine particles from the analysis sample.

The present disclosure may provide a particle detection system that enhances the detection capabilities for fine particles such as metals, metalloids, and/or compounds thereof, dissolved in a polar solvent, by controlling the temperature and/or pressure of the extractor 102 as described above, thereby instantaneously reducing the solubility of the fine particles dissolved in the polar solvent, so that the fine particles may be precipitated in the form of particles and separated from the polar solvent. In accordance with the present disclosure, it is possible to reduce the occurrence of semiconductor quality problems caused by fine particles, and also to promote productivity improvement.

The structure of the extractor 102 in accordance with an exemplary embodiment may be designed as a spherical or cylindrical structure, for example, to evenly distribute pressure, but is not limited thereto. A wall thickness of the extractor 102 may be designed to be sufficiently thick to withstand the operating pressure and temperature. The material of the extractor 102 is not limited as long as the material is a material that is not reactive with the supercritical fluid and is capable of withstanding high temperature and/or high pressure conditions, and as an example, high-strength stainless steel or alloy steel may be used.

The extractor 102 in accordance with an exemplary embodiment may include a pressure relief valve to safely release pressure in an overpressure situation. The pressure relief valve may be designed to automatically open and close when the pressure exceeds a predetermined range, or may manually open and close by an operator.

The separator 103 in accordance with an exemplary embodiment may be a space for separating the precipitated fine particles and the solvent that have been discharged from the extractor 102, and may include a filter 103a or a cyclone separator. For example, a filter made of chemically resistant polytetrafluoroethylene (PTFE), HAPES, UHMW-polyethylene (UPE), high density polyethylene (HDPE) or Nylon may be used as the filter 103a, but is not limited thereto. A pore size of the filter 103a may be, for example, 100 nm or less, and in other examples, 50 nm or less, 30 nm or less, or 10 nm or less. When the separator 103 includes the filter, the separator may be separated into a first region and a second region based on the filter 103a, for example. The mixture of the precipitated fine particles and the solvent that have been discharged from the extractor 102 may be introduced through a passage connected to the first region of the separator 103 based on the filter 103a. In this case, the solvent passes through the filter and moves to the second region, and the precipitated fine particles may not pass through the filter and remain in the first region. Here, the first region and the second region may refer to regions obtained by dividing the separator 103 based on the filter, for example. The separator 103 may include a cyclone separator. The cyclone separator is a device that separates particles and a solvent using a centrifugal force, so that the precipitated fine particles may be pushed to an outer wall by the centrifugal force and the solvent may be discharged along the center.

In accordance with an exemplary embodiment, the precipitated fine particles separated in the separator 103 may be mixed with a fluid for analysis and introduced into the analyzer 20.

The analyzer 20 in accordance with an exemplary embodiment may be characterized by including the above-described analyzers. In the analyzer 20, for example, the number of precipitated fine particles of a certain particle diameter size or larger and the ion concentration may be measured and the fine particle concentration may be converted by comparing the number and the concentration to the weight of the initially introduced polar solvent.

The preprocessor 10 in accordance with an exemplary embodiment may further include a recovery system 104 that recovers the supercritical fluid from the solvent separated in the separator 103.

The recovery system 104 in accordance with an exemplary embodiment may include a gas storage tank 104a and/or a liquid storage tank 104b. The gas storage tank 104a may be, for example, a space for storing a gas extracted by reducing the pressure of the solvent separated in the separator 103, and the liquid storage tank 104b may be, for example, a space for storing a liquid manufactured by cooling the gas. The supercritical fluid may be manufactured by heating and/or pressurizing the liquid discharged from the liquid storage tank 104b, and the manufactured supercritical fluid may be transferred to the supercritical fluid storage container 101.

The preprocessor 10 in accordance with an exemplary embodiment may further include a plurality of connecting pipes. The connecting pipe may be, for example, a pipe connecting the supercritical fluid storage container 101 and the extractor 102, a pipe connecting the extractor 102 and the separator 103, a pipe connecting the separator 103 and the recovery system 104, or a pipe connecting the recovery system 104 and the supercritical fluid storage container 101, but is not limited thereto. The connecting pipe may include, for example, a pump, a heater and/or a cooler, and the pump may be a pressurizing pump or a depressurizing pump. The connecting pipe may be non-reactive, for example, with supercritical fluids or polar solvents.

A third aspect of the present disclosure relates to a particle detection method.

Unless specifically stated otherwise, matters relating to the first aspect and/or the second aspect of the present disclosure may be equally applied to matters relating to the third aspect.

A particle detection method in accordance with an exemplary embodiment may include an operation of performing preprocessing prior to introduction of an analyzer, in which operation P1 of performing the preprocessing may include operation P11 of introducing an analysis sample in which a silicon precursor is dissolved in high-concentration sulfuric acid into the extractor 102, operation P12 of mixing supercritical carbon dioxide from the supercritical carbon dioxide storage container 101 into the extractor 102, operation P13 of precipitating the silicon precursor from the analysis sample by adjusting a temperature or a pressure of the extractor 102, and operation P14 of separating a solvent mixed with the precipitated silicon precursor in the separator 103, the temperature and pressure of the extractor in operation P12 of mixing the supercritical carbon dioxide from the supercritical carbon dioxide storage container 101 into the extractor may be 32° C. to 200° C. and 74 bar to 300 bar, respectively, and the temperature and pressure in operation P13 of precipitating the silicon precursor from the analysis sample may be adjusted to 32° C. to 85° C. and 130 bar to 250 bar, respectively.

The particle detection method in accordance with an exemplary embodiment may further include operation P15 of mixing the precipitated silicon precursor and with a fluid for analysis and/or operation P2 of analyzing the mixture (sample) with the analyzer 20.

The particle detection method in accordance with an exemplary embodiment may further include operation P16 of recovering the supercritical fluid from the solvent in the recovery system 104.

The present disclosure can provide a particle detection method and system with the improved detection ability for fine particles, such as metals, metalloids, and/or compounds thereof, dissolved in a polar solvent. In this way, the present disclosure can reduce the occurrence of semiconductor quality problems caused by fine particles, and also can promote productivity improvement.

In the above, the exemplary embodiments of the present disclosure have been described with reference to the accompanying drawings, but, the present invention is not limited to the exemplary embodiments and may be manufactured in various different forms and those of ordinary skill in the art to which the present disclosure pertains may understand that the additional or alternative exemplary embodiments may be embodied in other specific forms without departing from the technical spirit or essential features of the present disclosure. Therefore, it is to be appreciated that the exemplary embodiments described above are intended to be illustrative in all respects and not restrictive.

What is claimed is:

1. A particle detection method comprising:
performing preprocessing of an analysis sample in which fine particles are dissolved in a polar solvent,
wherein the performing of the preprocessing comprises:
mixing the analysis sample, in which fine particles are dissolved in a polar solvent, with a supercritical fluid;
precipitating the fine particles to form a mixture of polar solvent with precipitated fine particles and supercritical fluid; and
separating the polar solvent from the precipitated fine particles; and
introducing the precipitated fine particles to an analyzer configured to detect particles.

2. The particle detection method of claim 1, wherein the fine particles include at least one material selected from the group consisting of metals, metalloids, and compounds thereof.

3. The particle detection method of claim 1, wherein the polar solvent is at least one polar solvent selected from the group consisting of water; an inorganic solvent containing sulfuric acid, phosphoric acid, hydrochloric acid, nitric acid, hydrofluoric acid, ammonium hydroxide, or hydrogen peroxide; and an organic solvent containing acetic acid, dimethyl sulfoxide, methyl alcohol, ethyl alcohol, isopropyl alcohol, ethanol amine, or tetramethylammonium hydroxide.

4. The particle detection method of claim 1, wherein the supercritical fluid is at least one supercritical fluid selected from the group consisting of carbon dioxide, ethane, ethylene, propane, propylene, and chlorotrifluoromethane.

5. The particle detection method of claim 1, wherein the mixing of the analysis sample and the supercritical fluid is performed at a temperature of 32° C. to 200° C., or under a pressure of 74 bar to 300 bar.

6. The particle detection method of claim 1, wherein the precipitating of the fine particles comprises adjusting a pressure to a range of 130 bar to 250 bar.

7. The particle detection method of claim 1, wherein the precipitating of the fine particles comprises adjusting a temperature to a range of 32° C. to 85° C.

8. The particle detection method of claim 1, wherein a particle diameter size of the precipitated fine particles is 20 nm to 5 μm.

9. The particle detection method of claim 1, wherein the performing of the preprocessing further comprises separating the polar solvent mixed with the precipitated fine particles.

10. The particle detection method of claim 9, wherein the performing of the preprocessing further comprises recovering the supercritical fluid from the separated polar solvent.

11. The particle detection method of claim 10, wherein the recovering of the supercritical fluid from the separated polar solvent, comprises:
recovering a gas form of the supercritical fluid by depressurizing the separated polar solvent;
cooling and liquefying the recovered gas form of the supercritical fluid to form a liquefied gas of the supercritical fluid;
heating the liquefied gas of the supercritical fluid; and
pressurizing the liquefied gas of the supercritical fluid.

12. The particle detection method of claim 9, wherein the performing of the preprocessing further comprises mixing the precipitated fine particles with an analysis fluid.

13. The particle detection method of claim 1, wherein the analyzer is an inductively coupled plasma mass spectrometer (ICP-MS) or a laser particle counter (LPC).

14. A particle detection system comprising:
a preprocessor; and
an analyzer,
wherein the preprocessor comprises:
a supercritical fluid storage container configured to contain supercritical fluid;
an extractor configured to precipitate fine particles from an analysis sample by mixing the analysis sample with the supercritical fluid; and
a separator configured to separate precipitated fine particles and a solvent discharged from the extractor.

15. The particle detection system of claim 14, wherein the extractor maintains a temperature of 32° C. to 200° C. or a pressure of 74 to 300 bar, when mixing the supercritical fluid with the analysis sample.

16. The particle detection system of claim 14, wherein the extractor is controlled to reach a temperature of 32° C. to 85° C. when the extractor precipitates fine particles from the analysis sample.

17. The particle detection system of claim 14, wherein the extractor is controlled to reach a pressure of 130 bar to 250 bar when the extractor precipitates fine particles from the analysis sample.

18. The particle detection system of claim 14, wherein the separator includes a filter or a cyclone separator.

19. The particle detection system of claim 14, wherein the preprocessor further comprises a recovery system.

20. A particle detection method comprising:
performing preprocessing of an analysis sample;
wherein the performing of the preprocessing comprises:
introducing the analysis sample in which a silicon precursor is dissolved in high-concentration sulfuric acid into an extractor;
mixing supercritical carbon dioxide from a supercritical carbon dioxide storage container into the extractor; and
precipitating the silicon precursor from the analysis sample by adjusting a temperature or a pressure of the extractor to produce precipitated silicon precursor; and separating a solvent mixed with the precipitated silicon precursor in a separator;
wherein the temperature of the extractor in the mixing of the supercritical carbon dioxide from the supercritical carbon dioxide storage container into the extractor is 32° C. to 200° C. and ° C.,
wherein the pressure of the extractor in the mixing of the supercritical carbon dioxide from the supercritical carbon dioxide storage container into the extractor is 74 bar to 300 bar, and
wherein the temperature and pressure in the precipitating of the silicon precursor from the analysis sample are adjusted to 32° C. to 85° C. and 130 bar to 250 bar, respectively.
